(19) United States
(12) Patent Application Publication
(10) Pub. No.: US 2010/0152351 A1
(43) Pub. Date: Jun. 17, 2010

(54) OBSTRUCTING AND BONDING COATING, AND METHOD FOR PRODUCING SAME

(76) Inventor: Ping Li, Shanghai (CN)

Correspondence Address: 3M INNOVATIVE PROPERTIES COMPANY, PO BOX 33427, ST. PAUL, MN, 55133-3427, US

(21) Appl. No.: 12/516,588

(22) PCT Filed: Nov. 29, 2007
(86) PCT No.: PCT/US07/85871

§ 371 Date: Feb. 25, 2010

(30) Foreign Application Priority Data
Dec. 1, 2006 (CN) 200610166724.9

(51) Int. Cl. C08K 3/34; C08K 5/00; C08K 5/54

(52) U.S. Cl. 524/262; 524/445; 524/447

(57) ABSTRACT

The present invention provides an obstructing and bonding coating, comprising 0.2-5 parts by weight of a layered inorganic filler and 100 parts by weight of a bonding resin, wherein the layered inorganic filler is a silicate clay, and the bonding resin is a modified acrylate resin, a modified polyurethane resin, a modified acrylamide resin, a modified polyethyleneimine resin, or a mixture thereof. The present invention also provides a method for producing the obstructing and bonding coating.

### TECHNICAL FIELD

The present invention relates to an obstructing and bonding coating, in particular, to an obstructing and bonding coating for solving the problem of property decreasing during the use of a commercial labeling membrane or a polyvinyl chloride (PVC) adhesive tape. The present invention also relates to a method for producing the obstructing and bonding coating.

### BACKGROUND

A commercial labeling membrane product is structured as shown in FIG. 1. A printing layer 10, a PVC rolling membrane or a flow casting membrane 12, a pressure sensitive adhesive (PSA) layer 14, and a release paper or a release membrane 16, are generally sequentially laminated. A PVC adhesive tape product is structured as shown in FIG. 2. A release coating layer 20, a PVC rolling membrane or a flow casting membrane 22, and a PSA layer 24, are generally sequentially laminated.

To make the PVC membrane in the above products possess the ductility desirable for application, as well as to extrude it to form a rolling membrane or a flow casting membrane, 15-50% of a plasticizer is generally added therein. However, considering the cost and simplicity of processing, a low molecule plasticizer which easily migrates is generally added. Thus, the migrated low molecule substance and the plasticizer will enter into the PSA layer, thereby decreasing the bonding property and durability of the PSA. In particular, when a commercial labeling material is used for spray-drawing or printing processing such as screen printing, the downward penetration of an organic solvent in the printing ink layer will speed up the downward migration of the micromolecule plasticizer in the PVC layer, thereby accelerating the decrease of the bonding property of back adhesive, and affecting the durability of the product.

There are many reports concerning how to resist or obstruct the migration of a plasticizer, in which the most direct and effective method is to increase the molecular weight of the plasticizer by replacing a low molecular weight plasticizer with a high molecule polyester plasticizer to slow down the migration speed of plasticizer. However, the use of polyester plasticizer will increase the cost and decrease the flowability of the system, thus further increasing the processing difficulty of PVC membrane.

In U.S. Pat. No. 4,806,393, a layer of PVC modified by the introduction of functional groups which can be crosslinked is applied to a plasticized PVC. It is also attempted to obstruct the migration of a plasticizer by coating a layer of crosslinkable polyurethane (PU) coating, as stated in U.S. Pat. No. 4,045,600. It is also attempted to modify the structure of PSA to make it not sensitive to the migration of a plasticizer, as stated in U.S. Pat. No. 4,946,742, U.S. Pat. No. 5,049,608, U.S. Pat. No. 5,204,390, U.S. Pat. No. 4,605,592, U.S. Pat. No. 3,932,328 and U.S. Pat. No. 4,136,071. US 2004/0053037 A1 and U.S. Pat. No. 5,716,709 A respectively disclose a multilayer barrier coating, which comprises at least a layer of an organic material and at least a layer of a platelet inorganic material, wherein said platelet inorganic material includes a clay such as montmorillonite, and said coating has excellent obstructing property.

### SUMMARY

The aforementioned prior art methods do not address the technical problem to be solved in the present application, which is directed to providing an excellent obstructing property, while at the same time maintaining the bond between a PVC membrane and a lower layer of PSA. Purely seeking for the obstructing effect, an obvious boundary layer will be created between PVC membrane and PSA. Thus, although the migration of a low molecule substance is obstructed, the bonding force between PVC membrane and PSA will be greatly affected due to the formation of the boundary layer, thereby accelerating the decrease of durability of a commercial labeling membrane or a PVC adhesive tape.

The present application is directed to providing a low cost obstructing and bonding coating having an excellent obstructing and bonding property, which can be used for various commercial labeling membranes or adhesive tape products, and provides an excellent obstructing and bonding property. The present application is additionally directed to providing a method for producing the obstructing and bonding coating.

In one aspect, the present invention provides an obstructing and bonding coating, comprising 0.2-5 parts by weight of a layered inorganic filler and 100 parts by weight of a bonding resin, wherein the layered inorganic filler is a silicate clay, and the bonding resin is a modified acrylate resin, a modified polyurethane resin, a modified acrylamide resin, a modified polyethyleneimine resin, or a mixture thereof.

In one embodiment, the layered inorganic filler is a kaolin clay, a bentonitic clay, or a montmorillonite clay.

In another embodiment, the layered inorganic filler is a sodium-based montmorillonite clay.

In another embodiment, the bonding resin is an amino-modified acrylate resin, polyurethane resin, acrylamide resin and polyethyleneimine resin, a hydroxy-modified acrylate resin, polyurethane resin, acrylamide resin and polyethyleneimine resin, or a mixture thereof.

In another embodiment, the amount of the layered inorganic filler is 1 part by weight.

In the other aspect, the present invention provides a method for producing an obstructing and bonding coating, comprising:

(a) modifying a layered inorganic filler with an organic treating agent to form an organic-modified filler, wherein the layered inorganic filler is a silicate clay, and the organic treating agent is a long chain alkyl halogenated ammonium salt having a carbon chain length greater than 12;

(b) pre-treating the obtained organic-modified filler with a pre-treating agent to obtain a pre-treated filler, wherein the pre-treating agent is an oligomer of a bonding resin, bonding resin per se, or diluted bonding resin, or a resin selected from the group consisting of acrylate, amino-modified acrylate, acrylamide and isocyanate; the bonding resin is a modified acrylate resin, a modified polyurethane resin, a modified acrylamide resin, a modified polyethyleneimine resin, or a mixture thereof;

(c) blending the obtained pre-treated filler with the bonding resin at a temperature of 35-65° C. and 1000-3000 rpm,

wherein the weight ratio of the layered inorganic filler to the organic treating agent is 1:0.3 to 1:0.7, that of the pre-treating agent to the organic-modified filler is 0.4:1 to 2:1, and that of the organic-modified filler to the bonding resin is 1:500 to 1:20.

In one embodiment, the layered inorganic filler is a kaolin clay, a bentonitic clay, or a montmorillonite clay.

In another embodiment, the organic treating agent is a halogenated ammonium salt having a structure selected from the group consisting of HOOC(CH₂)₁₇NH₃⁺, CH₃(CH₂)₁₇N(CH₃)₃⁺, [CH₃(CH₂)₁₇]₂N(CH₃)₂⁺ and CH₃(CH₂)₁₇NH₃⁺.

In another embodiment, the bonding resin is an amino-modified acrylate resin, polyurethane resin, acrylamide resin and polyethyleneimine resin, a hydroxy-modified acrylate resin, polyurethane resin, acrylamide resin and polyethyleneimine resin, or a mixture thereof.

In another embodiment, the weight ratio of the layered inorganic filler to the organic treating agent is 1:0.5, that of the pre-treating agent to the organic-modified filler is 1:1, and that of the organic-modified filler to the bonding resin is 1:100.

### DESCRIPTION OF FIGURES

FIG. 1 illustrates the structure of a commercial labeling membrane product in the prior art.

FIG. 2 illustrates the structure of a commercial labeling adhesive tape product in the prior art.

FIG. 3 illustrates the structure of a product comprising an obstructing and bonding coating of the present invention.

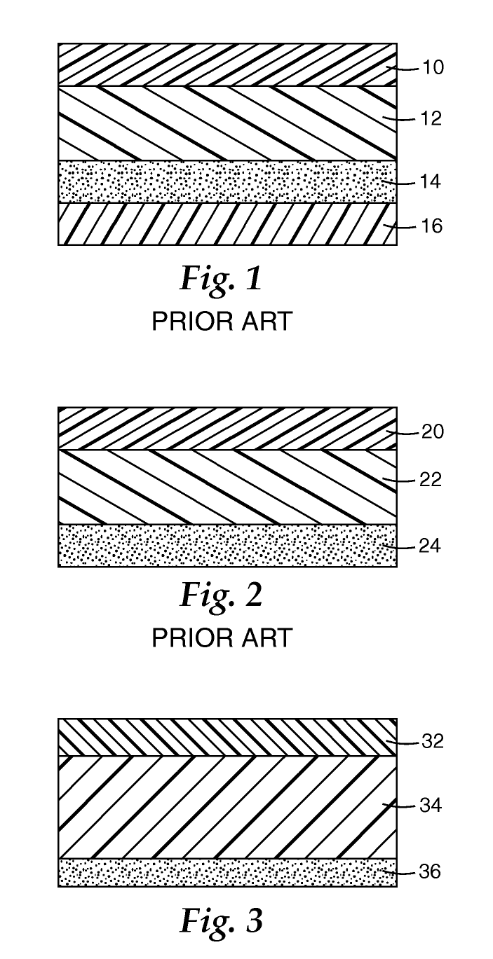

### DETAILED DESCRIPTION

Through extensive and intensive studies, it is found that it is able to produce a low cost obstructing and bonding coating agent having an excellent obstructing and bonding property by complexing a layered inorganic filler with a bonding resin in a certain manner, and to obstruct the downward penetration of a low molecule substance such as a plasticizer and improve the bonding between PVC membrane and PSA by coating the coating agent between the PVC membrane and PSA of the prior art product in a certain manner. The obstructing function is mainly derived from obstructing the penetration of the substance in a vertical direction by the oriented dispersed layered structure, while the excellent bonding property is derived from the bonding force of the bonding resin.

### Obstructing and Bonding Coating

The obstructing and bonding coating of the present invention comprises 0.2-5 parts by weight of a layered inorganic filler and 100 parts by weight of a bonding resin. The layered inorganic filler useful in the present invention can be a conventional layered inorganic filler in the art. The representative examples thereof include, but not limited to: a silicate clay, such as a kaolin clay, a bentonitic clay and a montmorillonite clay, in which a sodium-based montmorillonite clay is preferred.

The bonding resin useful in the present invention can be a conventional bonding resin in the art. The representative examples thereof include, but not limited to: a modified acrylate resin, a modified polyurethane resin, a modified acrylamide resin, a modified polyethyleneimine resin, or a mixture thereof The bonding resin can be a monocomponent resin, or a bicomponent (containing a crosslinking agent) resin which may form a crosslinking net, such as an amino-modified acrylate resin, polyurethane resin, acrylamide resin and polyethyleneimine resin, or a hydroxy-modified acrylate resin, polyurethane resin, acrylamide resin and polyethyleneimine resin, in which the amino-modified acrylate resin is preferred.

In the obstructing and bonding coating of the present invention, the amount of said layered inorganic filler is 0.2-5 parts by weight, preferably 1 part by weight.

### Method for Producing an Obstructing and Bonding Coating

The method for producing the obstructing and bonding coating in the present invention comprises:

(a) modifying said layered inorganic filler with an organic treating agent to form an organic-modified filler, wherein the organic treating agent is a long chain alkyl halogenated ammonium salt having a carbon chain length greater than 12 (C>12), such as a halogenated ammonium salt having a structure selected from the group consisting of HOOC(CH₂)₁₇NH₃⁺, CH₃(CH₂)₁₇N(CH₃)₃⁺, [CH₃(CH₂)₁₇]₂N(CH₃)₂⁺ and CH₃(CH₂)₁₇NH₃⁺, in which HOOC(CH₂)₁₇NH₃⁺ is preferred;

(b) pre-treating the obtained organic-modified filler with a pre-treating agent to obtain a pre-treated filler, wherein the pre-treating agent is an organic resin having excellent compatibility with said bonding resin, which may be an oligomer of the bonding resin, the bonding resin per se, or the diluted bonding resin, or may be a resin complexed with said bonding resin, containing an active group, and having the effect of increasing viscosity or crosslinking, such as acrylate, amino-modified acrylate, acrylamide and isocyanate, in which the amino-modified acrylate or isocyanate is preferred;

(c) blending the obtained pre-treated filler with the bonding resin at a temperature of 35-65° C. and 1000-3000 rpm,

wherein the weight ratio of the layered inorganic filler to the organic treating agent is 1:0.3 to 1:0.7, preferably 1:0.5; that of the pre-treating agent to the organic-modified filler is 0.4:1 to 2:1, preferably 1:1; and that of the organic-modified filler to the bonding resin is 1:500 to 1:20, preferably 1:100.

FIG. 3 illustrates the structure of a product comprising an obstructing and bonding coating of the present invention. The product 30 comprises a PVC membrane layer 32, an obstructing and bonding layer 34, as described above, and a pressure sensitive adhesive 36. The structure is produced as follows:

Swelling the purified layered inorganic filler into deionized water for soaking over night, then heating to 60-95° C. under sufficient agitation; slowly dropping said organic treating agent under high speed agitation, and continuing to agitate; then cooling to room temperature, conducting separation once reaching complete delamination, and washing to the extent that no halogen ion could be detected; then vacuum baking to obtain said organic-modified filler, grinding and sieving;

Soaking said organic-modified filler into an organic solvent such as ethyl acetate (EA), methyl ethyl ketone (MEK), methyl isobutyl ketone (MIBK), cyclohexanone and toluene, then slowly raising the temperature and keeping at 35-65° C.; then adding said pre-treating agent, and conducting high speed shear dispersion under 1000-10000 rpm to obtain a pre-treated filler;

blending said pre-treated filler with the bonding resin in an appropriate ratio at a temperature of 35-65° C. and 1000-3000 rpm; diluting the blended solution into an appropriate viscosity, i.e. 50-2000 cps; uniformly coating said blended solution onto a PVC membrane surface by a roll coating manner such as a bar rolling, a cobwebbing rolling and a comma rolling, or by a spray coating manner, and baking to form a membrane at an isothermic gradient of 35-85° C.; then realizing a horizontal direction arrangement of internal layered structure and PVC membrane by using the certain shear and orientation effect in a roll coating or spray coating process, thereby obstructing the plasticizer from penetration in the vertical direction;

bonding the coated PVC membrane with PSA at an appropriate temperature and pressure (bonding the coating with PSA), thus, the obtained coating having an excellent bonding property to make PVC membrane and PSA well bonded.

The obstructing and bonding coating of the present invention has an excellent obstructing property, which can resist or obstruct the penetration of a low molecule substance such as aqueous vapor and air, and of an organic substance such as a solvent, a plasticizer, a flexibilizer and other additives. Additionally, the obstructing and bonding coating of the present invention has an excellent bonding property, which can well bond an upper layer product with a lower layer product or a substrate, and effect nicely as an intermediate layer. The obstructing and bonding coating of the present invention can also be produced in a low cost.

The present invention is further illustrated in conjunction with the specific Examples. However, it should be understood that these Examples are intended to illustrate the present invention, not to constitute the limitation on the scope of the present invention. The experimental methods in the following Examples in which the specific experimental conditions are not recorded are generally performed according to the conventional conditions or those suggested by the manufacturer. Unless otherwise indicated, all percents and parts are based on the weight.

### Examples

### Example 1

10 g of an organic montmorillonite clay, which had been modified with HOOC(CH₂)₁₇NH₃⁺, was soaked into 500 g of a mixing solution of MIBK and MEK (30:70) for 4 hours. Then a high speed agitation (at 2000 rpm) in the mixture was conducted for 60 minutes, and the temperature thereof was elevated to 55° C. 30 g of an amino-modified polyethyl acrylate (20%) was slowly dropped into the mixture, then a high speed agitation was continued for 30 minutes to obtain a pre-intercalated dispersion. 40 ml of said pre-dispersion was mixed with 100 g of an amino-modified ethyl acrylate (40%), and a constant temperature of 60° C. was kept, then a high speed agitation was continued for 60 minutes to obtain a suspension of pre-intercalated complex, i.e. the obstructing and bonding agent, which was a non-homogeneous phase solution and should be used immediately once formulated.

Before coated, the suspension was sufficiently agitated, defoamed, and debubbled, and the obtained solution was uniformly coated onto a PVC membrane surface by using a depression printing roll coating process. After being sufficiently dried, the coated PVC membrane was bonded with PSA to obtain the membrane material.

The control product A (equal to the aftermentioned product B, without using the obstructing and bonding coating) was compared with the product B (using the obstructing and bonding coating between PVC membrane and PSA) as follows:

The product A and the product B were screen printed, respectively, and the printing ink was baked on the surface, then the viscosity of the drawing surface was measured.

The results were indicated in Table 1:

TABLE 1

| | | Aging in | | |
|---|---|---|---|---|
| 180° Peel | Room | oven at | Aging in | Aging in |
| Strength | Temperature | 80° C. | oven at 40° C. | oven at 80° C. |
| (N/m) | for 24 hours | for 7 days | for 14 days | for 14 days |
| Product A | 125 | 657 | 897 | 446 |
| Product B | 542 | 841 | 982 | 533 |

As seen from Table 1, after screen printing for 24 hours, the strength of the product A was significantly lower than that of the product B. And, after aging a period of time such as 14 days at 40° C. and 14 days at 80° C., the bonding strength of the product A was also lower than that of the product B. Therefore, as compared with the product A, the product B could significantly resist the solvent penetration and the migration of low molecule substance. Furthermore, the adhesion failure of the product B appeared to be interfacial failure, i.e. PSA was separated from the bonding surface, which indicated that the coating structure of the product B was beneficial to the bonding between PSA and PVC membrane.

### Example 2

10 g of an organic montmorillonite clay, which had been modified with HOOC(CH₂)₁₇NH₃⁺, was soaked into 500 g of a mixing solution of ethyl acetate and isopropanol (70:30) over night. Then sufficient agitation in the mixture was conducted for 10 minutes, and the temperature of the mixture was elevated to 60° C. 40 g of an amino-modified ethyl acrylate (20%) was slowly dropped into the mixture, then a high speed agitation (at 2500 rpm) was conducted for 30 minutes to obtain a pre-intercalated dispersion. Then 40 ml of said pre-dispersion was sufficiently mixed with 200 g of an amino-modified ethyl acrylate (40%) at a temperature of 60° C., and a high speed dispersing (at 2000 rpm) was conducted to obtain a suspension of pre-intercalated complex. After mixed, the suspension was defoamed, debubbled, then uniformly coated onto a PVC membrane surface by using die coating process, and was sufficiently dried, and the coated PVC membrane was bonded with PSA.

The control product C (equal to the aftermentioned product D, without using the obstructing and bonding coating) was compared with the product D (using the obstructing and bonding coating between PVC membrane and PSA).

The results were indicated in Table 2:

TABLE 2

| | | | | Measuring | |
|---|---|---|---|---|---|
| | | | | Method of | |
| | | | | 2# | |
| | | Static | | Bonding | |
| | | Adhesion | Dynamic | Force* | Aging in |
| 180° Peel | Room | Force at | Adhesion | (residual | oven at |
| Strength | Temperature | 70° C. | Force at | adhesive | 80° C. for |
| (N/m) | for 24 hours | (minutes) | 80° C. | amount) | 14 days |
| Product C | 898 | 5000 | Fail | >80% | 785 |
| Product D | 821 | >10000 | Pass | <10% | 902 |

*2# Bonding Force was a measuring method for evaluating the bonding property between PSA and PVC membrane, the specific operation of which was as follows: fixing on the steel plate a sample of 4 inches × 6 inches by a double face adhesive tape with the surface upward, adhibiting 0.5 inch of standard adhesive tape on the adhesive membrane by 4.5 pounds running roller, then 180° peeling the standard adhesive tape by a force of 12 inches/minute in a uniform velocity, and observing the sample adhesive amount transferred to the standard adhesive tape.
The less the sample adhesive amount transferred to the standard adhesive tape, the better the bonding between PSA and PVC membrane.

As seen from Table 2, after aging, the bonding property of the product D was better than that of the product C, and 2# Bonding Force test indicated that the bonding strength between PSA and PVC membrane in the product D was better. Furthermore, as compared with the product C, the static adhesion force and dynamic adhesion force of the product D was better, thus further indicating that the obstructing and bonding coating could improve the properties of the product.

### Example 3

The preceding steps were identical with those of Example 1. Then 40 ml of said pre-dispersion was mixed with 200 g of an acrylate-modified polyurethane solution (15%), and a high speed dispersing at a temperature of 60° C. and a sufficient agitation at 2000 rpm were conducted. Then the mixture was defoamed, debubbled, then uniformly coated onto PVC membrane by using a bar rolling process, and was bonded with the release paper coated with acrylate adhesive. Then the rolling was conducted to obtain a proper sample.

The control product E (equal to the aftermentioned product F, without using the obstructing and bonding coating) was compared with the product F (using the obstructing and bonding coating between PVC membrane and PSA).

The results were indicated in Table 3:

TABLE 3

| | | | | Measuring | |
|---|---|---|---|---|---|
| | | | | Method | |
| | | | | of 2# | |
| | | Static | | Bonding | |
| | | Adhesion | Dynamic | Force* | Aging in |
| 180° Peel | Room | Force at | Adhesion | (residual | oven at |
| Strength | Temperature | 70° C. | Force at | adhesive | 80° C. for |
| (N/m) | for 24 hours | (minutes) | 80° C. | amount) | 14 days |
| Product E | 729 | 2000 | Fail | >80% | 335 |
| Product F | 656 | 8000 | Pass | <10% | 514 |

As seen from Table 3, after aging, the bonding property of the product F was better than that of the product E, which indicated that the product F was less affected by a low molecule substance. Further, 2# Bonding Force of the product F was better than that of the product E, which indicated that the coating was beneficial to promoting the bonding between PSA and PVC membrane, thus naturally demonstrating that the adhesion force of the product F was better than that of the product E at a high temperature.

It should be understood the above Examples are merely illustrative, not constituting the limitation on the present invention. Without departing from the spirit and essence of the present invention, those skilled in the art may make various modifications or changes to the present invention. These modifications or changes fall within the scope of the accompanying claims.

1. An obstructing and bonding coating, comprising 0.2-5 parts by weight of a layered inorganic filler and 100 parts by weight of a bonding resin, wherein the layered inorganic filler is a silicate clay, and the bonding resin is a modified acrylate resin, a modified polyurethane resin, a modified acrylamide resin, a modified polyethyleneimine resin, or a mixture thereof.

2. The obstructing and bonding coating of claim 1, wherein the layered inorganic filler is a kaolin clay, a bentonitic clay, or a montmorillonite clay.

3. The obstructing and bonding coating of claim 1 or 2, wherein the layered inorganic filler is a sodium-based montmorillonite clay.

4. The obstructing and bonding coating of claim 1 or 2, wherein the bonding resin is an amino-modified acrylate resin, polyurethane resin, acrylamide resin and polyethyleneimine resin, a hydroxy-modified acrylate resin, polyurethane resin, acrylamide resin and polyethyleneimine resin, or a mixture thereof.

5. The obstructing and bonding coating of claim 1 or 2, wherein the amount of the layered inorganic filler is 1 part by weight.

6. A method for producing an obstructing and bonding coating, comprising:
(a) modifying a layered inorganic filler with an organic treating agent to form an organic-modified filler, wherein the layered inorganic filler is a silicate clay, and the organic treating agent is a long chain alkyl halogenated ammonium salt having a carbon chain length of being greater than 12;
(b) pre-treating the obtained organic-modified filler with a pre-treating agent to obtain a pre-treated filler, wherein the pre-treating agent is an oligomer of a bonding resin, bonding resin per se, or diluted bonding resin, or a resin selected from the group consisting of acrylate, amino-modified acrylate, acrylamide and isocyanate; the bonding resin is a modified acrylate resin, a modified polyurethane resin, a modified acrylamide resin, a modified polyethyleneimine resin, or a mixture thereof;
(c) blending the obtained pre-treated filler with the bonding resin at a temperature of 35-65° C. and 1000-3000 rpm,
wherein the weight ratio of the layered inorganic filler to the organic treating agent is 1:0.3 to 1:0.7, that of the pre-treating agent to the organic-modified filler is 0.4:1 to 2:1, and that of the organic-modified filler to the bonding resin is 1:500 to 1:20.

7. The method of claim 6, wherein the layered inorganic filler is a kaolin clay, a bentonitic clay, or a montmorillonite clay.

8. The method of claim 6 or 7, wherein the organic treating agent is a halogenated ammonium salt having a structure selected from the group consisting of HOOC(CH₂)₁₇NH₃⁺, CH₃(CH₂)₁₇N(CH₃)₃⁺, [CH₃(CH₂)₁₇]₂N(CH₃)₂⁺ and CH₃(CH₂)₁₇NH₃⁺.

9. The method of claim 6 or 7, wherein the bonding resin is an amino-modified acrylate resin, polyurethane resin, acrylamide resin and polyethyleneimine resin, a hydroxy-modified acrylate resin, polyurethane resin, acrylamide resin and polyethyleneimine resin, or a mixture thereof.

10. The method of claim 6 or 7, wherein the weight ratio of the layered inorganic filler to the organic treating agent is 1:0.5, that of the pre-treating agent to the organic-modified filler is 1:1, and that of the organic-modified filler to the bonding resin is 1:100.
